(19) United States
(12) Patent Application Publication
(10) Pub. No.: US 2003/0064014 A1
(43) Pub. Date: Apr. 3, 2003

(54) Purification of gases by pressure swing adsorption

(76) Inventors: Ravi Kumar, Allentown, PA (US); Shuguang Deng, Hillsborough, NJ (US)

Correspondence Address: Philip H. Von Neida, Intellectual Property Dept., The BOC Group, Inc., 100 Mountain Ave., Murray Hill, NJ, 07974, US

(21) Appl. No.: 09/922,125

(22) Filed: Aug. 3, 2001

(51) Int. Cl. B01D 53/34

(52) U.S. Cl. 423/210; 423/247

(57) ABSTRACT

A process for removing impurities from a gaseous feed stream is disclosed. Impurities such as hydrogen, water, carbon monoxide and carbon dioxide are removed from the gaseous feed stream in a vessel in a reaction zone having layers of adsorbent materials and oxidation catalysts. Preferably, the process is a pressure swing adsorption process prior to a cryogenic distillation unit.

### FIELD OF THE INVENTION

The present invention relates to a method for removing gaseous impurities from feed gas streams in a pressure swing adsorption unit. More particularly, the present invention provides for a method for removing hydrogen, carbon monoxide, water and carbon dioxide from a feed gas stream prior to its introduction into a cryogenic distillation unit.

### BACKGROUND OF THE INVENTION

Adsorption is well established as a unit operation for the production of pure gases, the purification of gases and their mixtures up-front, their further physical and/or chemical handling, and for the treatment of fluid waste streams. Purification and separation of atmospheric air comprises one of the main areas in which adsorption methods are widely used. For an increase of their efficiency, novel adsorbent formularies and processes of their utilization are being sought permanently.

One of the areas of strong commercial and technical interest represents pre-purification of air before its cryogenic distillation. Conventional air separation units (ASUs) for the production of nitrogen, N₂, and oxygen, O₂, and also for argon, Ar, by the cryogenic separation of air are basically comprised of two or at least three, respectively, integrated distillation columns which operate at very low temperatures. Due to these low temperatures, it is essential that water vapor, H₂O, and carbon dioxide, CO₂, is removed from the compressed air feed to an ASU. If this is not done, the low temperature sections of the ASU will freeze up making it necessary to halt production and warm the clogged sections to revaporize and remove the offending solid mass of frozen gases. This can be very costly. It is generally recognized that, in order to prevent freeze up of an ASU, the content of H₂O and CO₂ in the compressed air feed stream must be less than 0.1 ppm and 1.0 ppm or lower, respectively. Besides, other contaminants such as low-molecular-weight hydrocarbons and nitrous oxide, N₂O, may also be present in the air feed to the cryogenic temperature distillation columns, and they must as well be removed up-front the named separation process to prevent hazardous process regime.

A process and apparatus for the pre-purification of air must have the capacity to constantly meet the above levels of contamination, and hopefully exceed the related level of demand, and must do so in an efficient manner. This is particularly significant since the cost of the pre-purification is added directly to the cost of the product gases of the ASU.

Current commercial methods for the pre-purification of air include reversing heat exchangers, temperature swing adsorption, pressure swing adsorption and catalytic pre-purification techniques.

Reversing heat exchangers remove water vapor and carbon dioxide by alternately freezing and evaporating them in their passages. Such systems require a large amount, typically 50% or more, of product gas for the cleaning, i.e., regenerating of their passages. Therefore, product yield is limited to about 50% of feed. As a result of this significant disadvantage, combined with characteristic mechanical and noise problems, the use of reversing heat exchangers as a means of air pre-purification in front of ASUs has steadily declined over recent years.

In temperature swing adsorption (TSA) pre-purification of air, the impurities are removed from air at relatively low ambient temperature, typically at about (5-15)° C., and regeneration of the adsorbent is carried out at elevated temperatures, e.g., in a region of about (150-250)° C. The amount of product gas required for regeneration is typically only about (10-25)% of the product gas. Thus, a TSA process offers a considerable improvement over that of utilizing reversing heat exchangers. However, TSA processes require evaporative cooling or refrigeration units to chill the feed gas and heating units to heat the regeneration gas. They may, therefore, be disadvantageous both in terms of capital costs and energy consumption despite of being more cost-effective than the reversing heat exchangers' principle referred to above.

Pressure swing adsorption (PSA) (or pressure-vacuum swing adsorption (PVSA)) processes are an attractive alternative to TSA processes, for example, as a means of air pre-purification, since both adsorption and regeneration via desorption, are performed, as a rule, at ambient temperature. PSA processes, in general, do require substantially more regeneration gas than TSA processes. This can be disadvantageous if high recovery of cryogenically separated products is required. If a PSA air pre-purification unit is coupled to a cryogenic ASU plant, a waste stream from the cryogenic section, which is operated at a pressure close to ambient pressure, is used as purge for regenerating the adsorption beds. Feed air is passed under pressure through a layer of particles of activated alumina, to remove the bulk of H₂O and CO₂, and then through a layer of zeolite particles such as of the FAU structural type, e.g., NaX zeolite, to remove the remaining low concentrations of H₂O and CO₂. Arrangement of the adsorbent layers in this manner is noted to increase the temperature effects, i.e., temperature drops during desorption, in the PSA beds. In other configurations, only activated alumina is used to remove both H₂O and CO₂ from feed air. This arrangement is claimed to reduce the temperature effects.

In addition, some applications require the removal of H₂ and CO from the ambient air before processing in the cryogenic distillation column to produce H₂ and CO, free nitrogen, oxygen, argon and other air components. At present, the TSA process has to be used for such applications. This results in higher costs of the pre-purification system for these processes.

### SUMMARY OF THE INVENTION

The present invention provides for a process for removing gaseous impurities including H₂ and CO from a feed gas stream comprising the steps of:

a) removing water from the feed gas stream;

b) contacting the feed gas stream with an oxidation catalyst to convert carbon monoxide to carbon dioxide;

c) removing carbon dioxide from the feed gas stream;

d) contacting the feed stream gas with a catalyst to convert hydrogen to water; and

e) removing the water generated by converting the hydrogen.

Optionally, additional layers may be employed to remove trace hydrocarbons and oxides of nitrogen from the feed stream gas. Preferably, the feed stream gas is air and the impurities are removed in a pressure swing adsorption (PSA) process prior to the air being fed to a cryogenic distillation unit in an air separation unit (ASU).

### DETAILED DESCRIPTION OF THE INVENTION

The present invention provides for a process for removing gaseous impurities from a gas feed stream prior to its introduction into a cryogenic distillation column of an air separation unit. The process comprises a pressure swing adsorption process for removing water, hydrogen, carbon monoxide and carbon dioxide as gaseous impurities from the feed stream gas.

The process comprises passing a feed stream gas containing these impurities through a five-layer bed. In the first layer, water is adsorbed using a typical water adsorbent. In the second layer, a catalyst oxidizes carbon monoxide to carbon dioxide. In the third layer, ambient carbon dioxide and carbon dioxide generated in the second layer is removed. In the fourth layer, a catalyst oxidizes hydrogen into water, and in the last and fifth layer, moisture generated in the fourth layer is adsorbed. The five layers are present in a single treatment zone, preferably in a single vessel which will include the three adsorbent layers and the two catalyst layers.

The first adsorbent layer may be any adsorbent for water such as activated alumina, silica gel or an X type zeolite such as NaX zeolite. This layer may also be a composite of these materials.

The second layer containing the oxidation catalyst is typically a metal oxide such as a nickel oxide or mixtures of oxides of manganese and copper. Preferably, the catalyst material is a Hopcalite type catalyst such as Carulite®-300 manufactured by the Carus Chemical Company.

The third layer contains an adsorbent for carbon dioxide removal such as activated alumina, silica gel or an X type zeolite such as NaX zeolite. Preferably, the third layer adsorbent material also adsorbs water and may also be a composite material. The third layer type X zeolite material is preferably a sodium LSX type zeolite which is a zeolite X type material with a silicon to aluminum atomic ratio in the range between 0.9 and 1.1.

The fourth layer is a supported palladium or other noble metal catalyst such as an egg shell type palladium catalyst available from Engelhard but preferably is a palladium based catalyst on a hydrophobic support or a catalyst comprising promoted platinum, palladium and tin oxide on a support available as Sofnocate from Molecular Products Co.

The fifth layer removes the moisture generated in the fourth layer. It may be any adsorbent for water such as activated alumina, silica gel or an X type zeolite such as NaX zeolite. This layer may also be a composite of these materials.

The optional sixth and seventh layers can be employed to remove trace hydrocarbons and oxides of nitrogen. These layers may also be composite layers. Typically, the hydrocarbon adsorbent is selected from the group consisting of types A and X zeolites and silica gel. The oxides of nitrogen adsorbent is typically selected from the group consisting of zeolites types A, X or Y.

In alternative embodiments of the present invention, the steps may be performed in different sequences. For example, the step of contacting the feed stream gas with a catalyst to convert hydrogen to water may be performed before removing carbon dioxide from the feed gas stream. Also the step of removing carbon dioxide from the feed gas stream can be performed before the feed gas stream contacts an oxidation catalyst to convert carbon monoxide to carbon dioxide. Under this sequence of steps, water is also removed by the carbon dioxide removal adsorbent.

The pressure swing adsorption process of the present invention can be performed at any of the usual and well-known pressures employed for gas phase pressure swing adsorption processes. This pressure envelope may vary widely but is dependent upon the pressure at which adsorption takes place as well as the pressure at which the desorption of the gas occurs. Typically, this ranges about 20 bara in the adsorption step to about 0.05 bara in the purge step with a range of about 10 bara to about 0.15 bara preferred and a range of about 6 bara to about 1 bara most preferred. The temperature at which the pressure swing adsorption is carried out will typically range from about 5° C. to about 55° C. for the adsorption step. However, temperatures as high as 200° C. may be employed.

The invention will now be described with respect to particular examples thereof which should not be construed as limiting the scope thereof.

### EXAMPLES

### Example 1

PSA/PPU experiments were conducted in a one bed PSA unit measuring 2.14 inches in diameter and 91 inches in height. The bed was packed with 67 inches of activated alumina available from Alcan as AA300 at the bottom, 12 inches of the Carulite®-300 material, then 12 inches of Sofnocat catalyst. Table 1 lists the experimental conditions.

TABLE 1

| | |
|---|---|
| Feed Step: | 12 minutes at a feed pressure |
| | of 80.5 psia and a feed |
| | temperature of 25° C., |
| | air flow rate of 3.88 scfm |
| Vent Step: | 1 minute |
| Purge Step: | 9 minutes, purge gas pressure |
| | of 22.7 psia and a temperature |
| | of 25° C. and purge gas |
| | nitrogen flow rate of 3.5 scfm |
| Re-Pressurization Step: | 2 minutes with nitrogen from |
| | the top of the bed |

Ambient air was used as feed in this example. A RGA-5CO/H2 Trace analyzer was used to measure hydrogen and carbon monoxide concentrations in the feed stream gas, the feed stream gas after the Carulite layer and product stream. Table 2 summarizes the hydrogen and carbon monoxide concentrations in the different gas streams measured during feed step after three weeks of continuous cyclic experiments.

TABLE 2

| | Feed End | | | | | |
|---|---|---|---|---|---|---|
| | H₂ | | After Carulite | | Product | |
| Time | (ppb) | CO(ppb) | H₂(ppb) | CO(ppb) | H₂(ppb) | CO(ppb) |
| 0 | 207.1 | 114.9 | | | | |
| 3 | | | 191.7 | 0.2 | 1.0 | 0.9 |
| 9 | | | 208.3 | 0.4 | 7.2 | 0.7 |
| 12 | | | 211.9 | 0.0 | 10.1 | 1.3 |

The results as summarized in Table 2 clearly show that carbon monoxide was completely removed by the Carulite oxidation catalyst while hydrogen was effectively removed from approximately 200 ppb to about 10 ppb by the Sofnocat oxidation catalyst under the experimental conditions.

### Example 2

Experiments similar to those described in Example 1 were repeated with a higher hydrogen and carbon monoxide air feed by injecting 2% hydrogen and 3.22% carbon monoxide into the feed air. The results of this testing are given in Table 3.

TABLE 3

| | Feed End | | | | | |
|---|---|---|---|---|---|---|
| | H₂ | | After Carulite | | Product | |
| Time | (ppb) | CO(ppb) | H₂(ppb) | CO(ppb) | H₂(ppb) | CO(ppb) |
| 0 | 3120.5 | 5024.0 | | | | |
| 3 | | | 350.0 | 3.6 | 0.0 | 2.0 |
| 6 | | | 589.6 | 2.8 | 0.0 | 1.8 |
| 9 | | | 911.0 | 1.4 | 227.8 | 2.4 |
| 12 | | | 2417.3 | 4.1 | 546.8 | 2.6 |

As demonstrated in Table 3 and Example 2, all the carbon monoxide in the air, approximately 5000 ppb, was effectively removed by the Carulite oxidation catalyst layer. Hydrogen was partially removed by the Carulite and further removed by the Sofnocat catalyst. H₂ broke through from the product stream and reached 546.8 ppb at the end of the feed step. However, more than 95% of hydrogen in the feed air was removed by a combination of the Carulite and Sofnocat catalysts during the feed step.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the present invention.

Having thus described the invention, what we claim is:

1. A process for removing impurities from a gaseous feed stream comprising:
a) removing water from said gaseous feed stream;
b) contacting said gaseous feed stream with an oxidation catalyst to convert carbon monoxide to carbon dioxide;
c) removing said carbon dioxide from said feed gas stream;
d) contacting said gaseous feed stream with an oxidation catalyst to convert hydrogen to water; and
e) removing said water from said gaseous feed stream.

2. The process as claimed in claim 1 wherein said gaseous feed stream is air.

3. The process as claimed in claim 1 wherein said impurities are selected from the group consisting of hydrogen, water, carbon monoxide and carbon dioxide.

4. The process as claimed in claim 1 wherein said process is a pressure swing adsorption process.

5. The process as claimed in claim 1 wherein step (a) comprises contacting said gaseous feed stream with a water removing adsorbent.

6. The process as claimed in claim 5 wherein said water removing adsorbent is selected from the group consisting of activated alumina, silica gel, zeolites and combinations thereof.

7. The process as claimed in claim 1 wherein said oxidation catalyst of step (b) is a mixture of manganese and copper oxides.

8. The process as claimed in claim 7 wherein said mixture of manganese and copper oxide is MnO₂—CuO.

9. The process as claimed in claim 1 wherein said oxidation catalyst of step (d) is a palladium based catalyst on a hydrophobic support.

10. The process as claimed in claim 1 wherein said oxidation catalyst of step (d) is a supported promoted platinum, palladium and tin oxide based catalyst.

11. The process as claimed in claim 1 wherein step (c) comprises contacting said gaseous feed stream with a carbon dioxide removing adsorbent.

12. The process as claimed in claim 11 wherein said carbon dioxide removing adsorbent is selected from the group consisting of zeolites, activated alumina, silica gel and combinations thereof.

13. The process as claimed in claim 1 further comprising contacting said gaseous feed stream with an adsorbent to remove trace hydrocarbons and oxides of nitrogen.

14. The process as claimed in claim 1 further comprising the step of cryogenically separating the product of the pressure swing adsorption process.

15. The process as claimed in claim 1 wherein said step (d) is performed before step (c).

16. The process as claimed in claim 1 wherein step (e) comprises contacting said gaseous feed stream with a water removing adsorbent.

17. The process as claimed in claim 16 wherein said water removing adsorbent is selected from the group consisting of activated alumina, silica gel, zeolites and combinations thereof.

18. The process as claimed in claim 17 wherein said water removing adsorbent will also remove carbon dioxide from said gas stream.

19. The process as claimed in claim 1 wherein step (c) is performed prior to step (b).

20. The process as claimed in claim 19 wherein H₂O is also removed in step (c).

21. A pressure swing adsorption process for removing impurities from a gaseous feed stream comprising:
passing said gaseous feed stream though a reaction zone containing four layers wherein the first layer comprises a water adsorbent; the second layer comprises an oxidation catalyst for converting carbon monoxide to carbon dioxide; the third layer comprises an oxidation catalyst for converting hydrogen to water; and the fourth layer comprises a carbon dioxide adsorbent.

22. The process as claimed in claim 21 wherein said gaseous feed stream is air.

23. The process as claimed in claim 21 wherein said water removing adsorbent is selected from the group consisting of activated alumina, silica gel, zeolites and combinations thereof.

24. The process as claimed in claim 21 wherein said oxidation catalyst for converting carbon monoxide to carbon dioxide is a mixture of manganese and copper oxide.

25. The process as claimed in claim 24 wherein said mixture of manganese and copper oxide is MnO₂—CuO.

26. The process as claimed in claim 21 wherein the oxidation catalyst for converting hydrogen to water is a palladium based catalyst on a hydrophobic support.

27. The process as claimed in claim 21 wherein said oxidation catalyst for converting hydrogen to water is a supported promoted platinum, palladium and tin oxide based catalyst.

28. The process as claimed in claim 21 wherein said carbon dioxide adsorbent is selected from the group consisting of zeolites, activated alumina, silica gel and combinations thereof.

29. The process as claimed in claim 21 wherein said pressure swing adsorption process operates at a range of 20 bara in the adsorption step to about 0.05 bara in the purge step.

30. The process as claimed in claim 21 wherein said pressure swing adsorption process operates at a temperature in the range from about 5° C. to about 55° C. for the adsorption step.
